(19) United States
(12) Patent Application Publication
(10) Pub. No.: US 2002/0179282 A1
(43) Pub. Date: Dec. 5, 2002

(54) Beverage cooler for automobile

(76) Inventor: Andrew Frederich Kutzner, Oldsmar, FL (US)

Correspondence Address: ANDREW F. KUTZNER, 4906 TURTLE CREEK TRAIL, OLDSMAR, FL, 34677, US

(21) Appl. No.: 10/093,923

(22) Filed: Mar. 11, 2002

Related U.S. Application Data
(60) Provisional application No. 60/290,786, filed on May 15, 2001.

(51) Int. Cl. F28F 1/00; F28F 7/00; B60H 1/32; A47K 1/08

(52) U.S. Cl. 165/41; 165/80.1; 62/244; 248/311.2

(57) ABSTRACT

A beverage cup holder for cooling and heating the contents in the cup by using he vehicle air conditioning system including a cup holder with a securing attachment at one end to secure the cup holder to the Dash air vent outlets of the automotive air conditioning system. When the cup holder is attached to the air conditioning system outlet, the air flow coming out of the air conditioning system is directed directly onto the cup holder and thus regulates the temperature by cooling or heating of the beverage therein.

This application is based upon U.S. Provisional patent application Ser. No. 60/290,786, filed May 15, 2001.

The invention relates to a beverage cooler or warmer for use in automotive vehicles.

Vehicle occupants commonly desire either warm or cool beverages when traveling in a vehicle. It is often difficult to maintain the temperature of warm or cool beverages in an automotive vehicle for an extended period of time. The present invention provides a “Holder” which connects to the Dash air vent outlets of the automotive air conditioning and heating system. In this way warm or cool air from the air conditioning and heating system outlet is directed directly onto the Holder to heat or cool whatever is placed in the Holder when the temperature conditioning system is in operation.

Accordingly, it is the object of the present invention to provide a device to regulate the temperature of beverages or whatever is placed in the Holder by using the air flow of the air conditioning and heating system of the vehicle, without loosing or affecting any temperature values of the air temperature system to the passengers or interior of the vehicle.

Another object of the present invention is to provide a device for regulating the temperature of beverages or whatever is placed in the Holder for an extended period of time.

The above-mentioned and other objects and the advantages of this invention, and the manner of obtaining them, will become more apparent and the invention will be better understood by reference to the following description of embodiment of the invention taken in conjunction with the accompanying drawings, wherein:

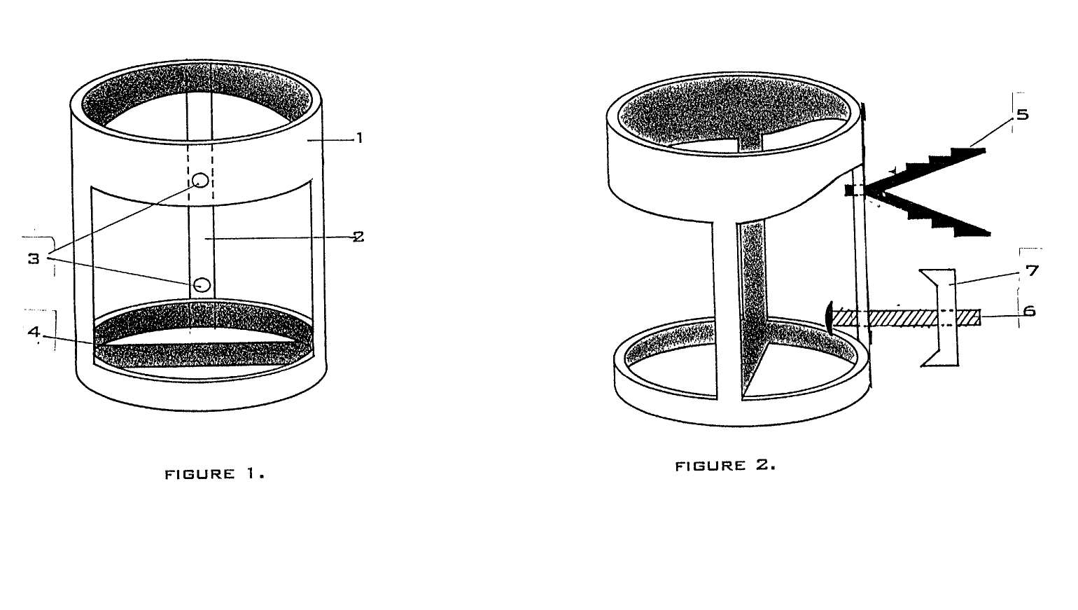

FIG. 1 is a perspective view of the beverage cooler Holder according to the present invention;

FIG. 2 is a perspective side view of the beverage cooler Holder showing the hardware used to attach the beverage cooler to the vehicle dash airflow outlets according to the present invention.

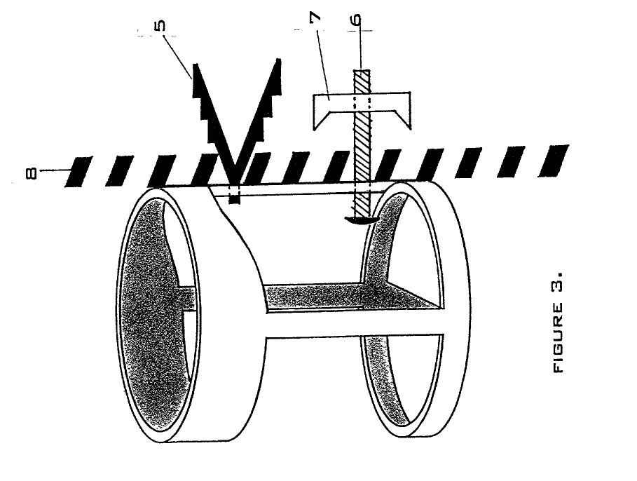

FIG. 3 is a perspective view of the beverage cooler Holder showing how the beverage cooler is attached to the vehicle dash airflow outlets grates according to the present invention.

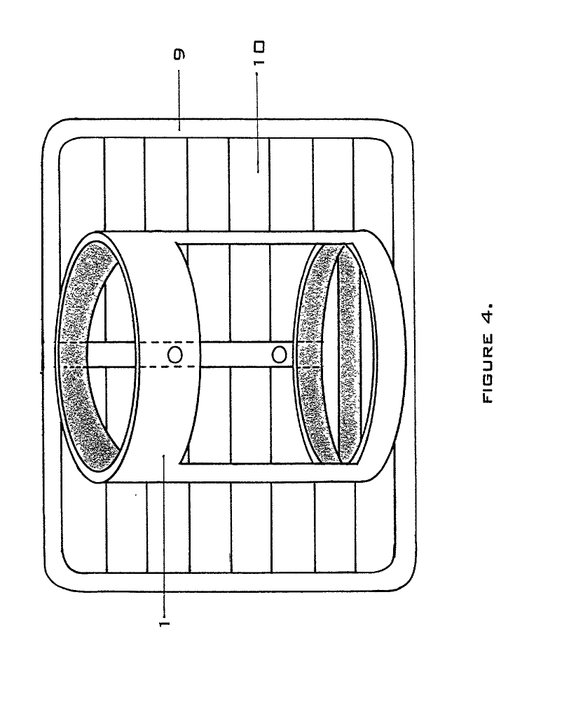

FIG. 4 is a perspective view of the beverage cooler Holder showing it positioned on the vehicle dash airflow outlets according to the present invention.

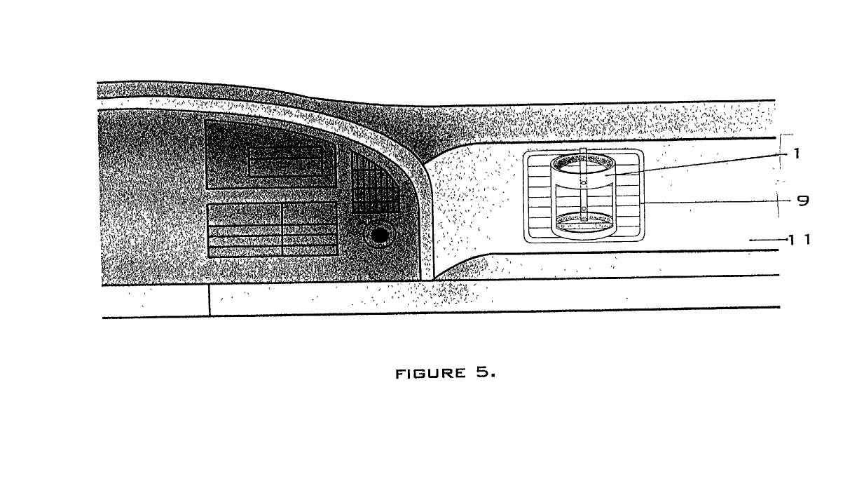

FIG. 5. is a perspective view of the beverage cooler Holder shown employed in a vehicle as attached to the dash airflow outlets according to the present invention.

Corresponding reference characters indicate corresponding parts throughout the several views. Although the drawings represent embodiments of the present invention, the drawings are not necessarily to scale and certain Features may be exaggerated in order to better illustrate and explain the present invention.

Referring to FIG. 1. of the drawings, a container (Holder) (1) made of solid material and formed in such a way to allow maximum free area at rear end to allow maximum air flow onto the container. The rear end vertical strut (2) has several holes (3) to accommodate the hardware used to attach the Holder to the Dash air vent outlet and to allow alignment on Dash air vent outlet grates. A (4) base is provided to prevent the contents placed into the Holder from falling through it.

Referring to FIG. 2. of the drawings item (5) shows a Spring Clip with serrated edges designed to hook onto the Grates of the Dash air vent, and item (6) shows a machine screw with (7) a Wing nut or Spring wing toggle nut designed to engage against the Dash air vent grates when tightened.

Referring to FIG. 3 of the drawings show the Wing nut bolt (6) and (7) Spring clip as engaged against the rear end of the (8) Dash air flow grates.

Referring to FIG. 4. shows the (1) Holder positioned onto the (9) Dash air vent outlet and (10) Air vent grates.

Referring to FIG. 5. shows the general view of the (1) Holder as attached to (9) Air vent outlet of the vehicle (11) Dash.

While this invention has been described as having exemplary embodiments, the present invention can be further modified within the spirit and scope of this disclosure. This application is therefore intended to cover any variations, forms, uses or adaptations of the invention using ist general principles. Further, this application is intended to cover such from the present disclosure as come within known or customary practices in the art to which this invention pertains and which fall within the limits of the appended claims.

What is claimed is:

1. A device for heating and cooling beverages, or other, used in conjunction with a vehicle air conditioning system in combination with a beverage container holder, said air conditioning system including an outlet for discharging heated or cooled air into the passenger compartment of the vehicle, said device comprising:
a container designed to hold beverage or other containers
hardware designed to easily attach or remove the holding device to or from the dash air vent outlets of the vehicle. The hardware comprises bolts with with wing nuts, or spring wing toggle nuts, and or spring clips with serrated surfaces designed to the firmly attach the container device directly onto the dash air vent outlet grates thus allowing close and maximum contact with the temperatured air coming out of the air vent, yet not impairing or affecting the desired temperature conditioning of the interior of the vehicle.

2. The device of claim 1. said outlet being covered by vent grate, said securing means including bolts and nuts with resilient arms extending axially from said one end, each of said arms having a finger extending therefrom, said fingers releasable engaging said vent grate.

3. The device of claim 2. said securing means also includes a spring type clip having fingers extending axially from the flat outer surface of said clip to allow said fingers releasably engaging said vent grate.

4. A device for heating and cooling beverages or whatever is placed in said device, for attachment to a vehicle air conditioning system, said air conditioning system including an outlet for discharging heated and cooled air into the passenger compartment of the vehicle, said device comprising:
a container designed to hold beverage or other containers
means connected to one end of said container for removably securing said container to said outlet
